(19) United States
(12) Patent Application Publication
(10) Pub. No.: US 2026/0192419 A1
(43) Pub. Date: Jul. 9, 2026

(54) MODULAR TOOL

(71) Applicant: CEMBRE S.P.A., Brescia (IT)

(72) Inventors: Gualtiero BAREZZANI, Brescia (IT); Davide NICOLAI, Brescia (IT); Michele ORIZIO, Brescia (IT); Samuel VEGLIANTI, Brescia (IT)

(21) Appl. No.: 19/134,703

(22) PCT Filed: Dec. 14, 2023
(86) PCT No.: PCT/IB2023/062677

§ 371 Date: May 30, 2025

(30) Foreign Application Priority Data
Feb. 17, 2023 (IT) 102023000002772

(51) Int. Cl. B25B 21/00; B25F 5/02

(52) U.S. Cl. CPC B25B 21/002; B25F 5/02

(57) ABSTRACT

A portable tool (100) includes a working shaft (2), an electric motor (3), a reducer (6), an electronic control system (7) with an actuation device (5, 5′), a memory (8) in which a calibration association between the working torque or force M of the tool (100) and a corresponding electric current (I) absorbed by the motor (3) is stored, a motor module (14) with its motor housing (15) which houses the electric motor (3) and an electronic motor control board (16), a reducer module (17) with its reducer housing (18) which houses the reducer (6), a handle module (19) with its supporting structure (20) which forms gripping handles (21), a control panel (22) with its panel housing (23) which supports a user interface (10) with a display (24) and a parameter selection member (11), wherein the motor housing (15), the reducer housing (18), the supporting structure (20) and the panel housing (22) are individually self-supporting distinct components reversibly connectable to one another to form the tool (100).

The present invention relates to a modular tool, for example a modular portable wrench, and with electric motor and battery and/or which can be powered by a wire connection, in particular for operations of screwing and unscrewing bolts, nuts and screws to rails and sleepers in the construction and maintenance of railway lines, for example for screwing and unscrewing so-called “connectors” to the sleepers, which connections in turn hold the rail tight against the sleeper.

There are known wrenches having a motor for generating a rotary motion, an actuation switch for actuating the motor, a working shaft, a reducer connected between the motor and the working shaft so as to transmit and demultiply the rotary motion from the motor to the working shaft and to rotate the working shaft, an electronic control system connected to a source of electricity and the actuation switch, as well as a handle structure for manually gripping the wrench.

In railway constructions, two main applications are identifiable:
The creation of the joints of the rails by perforated plates arranged on both sides of the perforated web of two adjoining rails and screwed by means of horizontal bolts, so as to form the continuous iron surface.
The anchoring of the rail connections to the sleepers by vertical screws. Such an application requires approximately vertical screwing or unscrewing from the top.

A typical screwing of a threaded joint has a first more or less lengthy screwing step in which the head of the screw or nut is brought close to the abutment, and a second true tightening step in which occurs the torque tightening of the screw or nut against the abutment. Similarly, unscrewing a threaded joint has a first loosening step of the tightening between the screw or nut and the abutment, and a second more or less lengthy step for the complete separation of the two threaded members from each other.

The tightening and loosening steps of the tightening require high torques obtainable, for example by a significant multiplication of the torque, which results in a proportional reduction of rotation speed. Contrarily, the approaching and removing steps of the threaded member with respect to the abutment can be performed with low torques and higher speeds, obtainable by a low torque multiplication with proportional increase in the screwing/unscrewing speed.

In this respect, the wrench reducer of the prior art is switchable between a first configuration (hereinafter “fast gear”) in which the screwing speed is high and the screwing torque is low, and a second configuration (hereinafter “slow gear”) in which the screwing speed is low and the screwing torque is high. The switching occurs, for example, by engaging or disengaging one or more reduction stages depending on the deformation state of an elastic spring connected to the reducer.

This known switching solution is mechanically complex, costly to manufacture and assemble, difficult to calibrate accurately, not synchronisable with a possible electronic control of the motor, and not directly influenceable or monitorable by an electronic control system of the wrench.

This prevents, for example, an easy adjustment or setting of the resistant torque value at which the reducer switching between the fast gear and low gear is to occur.

Moreover, in the prior art, the separation of the reducer switching from the screwing torque control and motor control can, under certain circumstances, lead to operation interruptions and anomaly signals due only to the lack of coordination of the control of all the wrench functions by a single control system and process.

Lastly, the gear change mechanism involves increased axial and radial encumbrance of the reducer with respect to reducers without gear change.

The disadvantages mentioned lead to considering using wrenches with a reducer without speed change, where however, the reducer and the electric motor are sized to provide both the desired screwing speed and the maximum torque required to complete the tightening of the threaded connection. These wrenches are not versatile for broad screwing torque ranges and broad screwing speed ranges, rather they are designed for very specific applications.

This means that for different screwing applications (with different screwing torques and screwing speeds), it will be predictably necessary to size the electric motor as well as the reducer differently each time.

Similar needs can also arise with portable tools with different electric motor and reducer other than wrenches, but which are to be possibly compact and designed for operating speed ranges and ranges of torque or maximum force achievable, for example trimmers, crimpers, compression and/or cutting tools, etc.

Therefore, it is the object of the present invention to provide, in an industrially efficient and affordable manner, a tool, in particular a wrench, having an electric motor and a reducer, having an overall possibly compact structure, and which allows a combination of motor sizing and reducer sizing and motor control tailored to a determined application.

Within the scope of the main object, it is a particular object of the invention to provide a tool having an electric motor and reducer, in particular a wrench, having features such as to reduce the manufacturing, assembly and maintenance cost of the tool.

At least some of the objects listed above are achieved by a tool, in particular a wrench, according to claim 1. The dependent claims relate to preferred and advantageous embodiments. Some of the objects of the invention are subordinate to others or even independent of others. Some of the embodiments of the dependent claims achieve single or multiple objects in a synergistic or independent manner.

In order to better understand the invention and appreciate the advantages thereof, some non-limiting exemplary embodiments will be described below with reference to the drawings, in which:

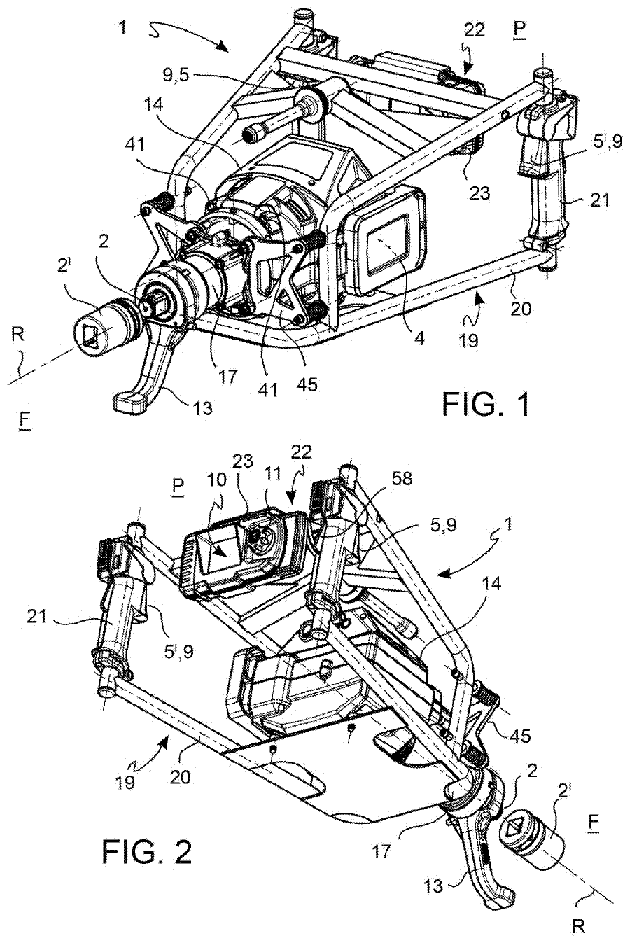

FIGS. 1 and 2 are perspective views of a tool (a wrench) according to an embodiment;

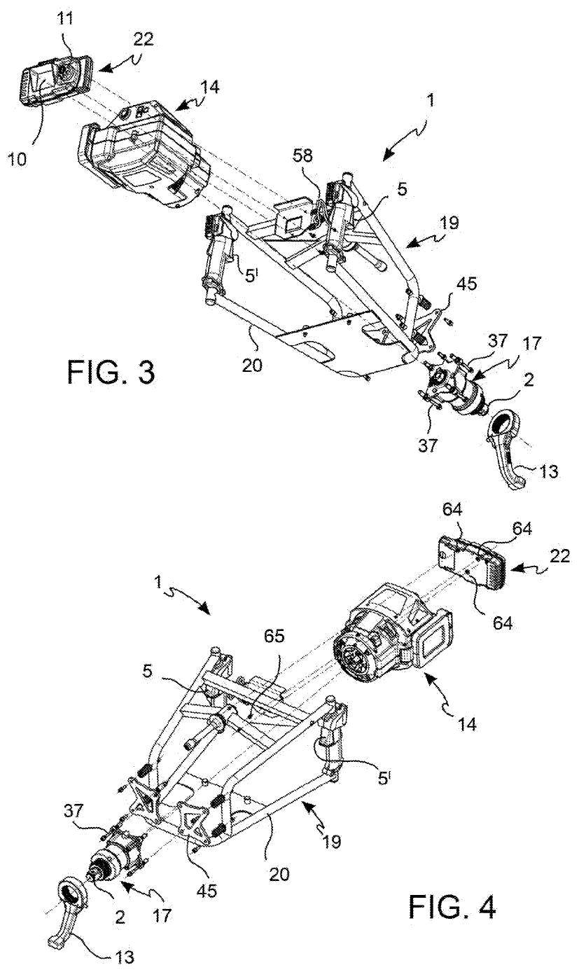

FIGS. 3 and 4 are exploded perspective views of the tool (wrench) in FIG. 1;

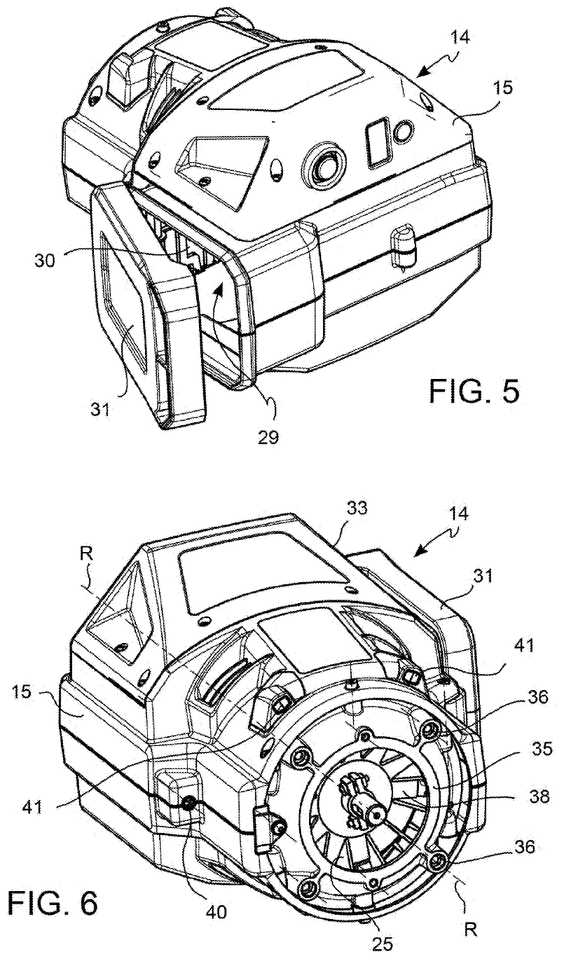

FIGS. 5 and 6 are perspective views of a motor module of the tool (wrench) in FIG. 1;

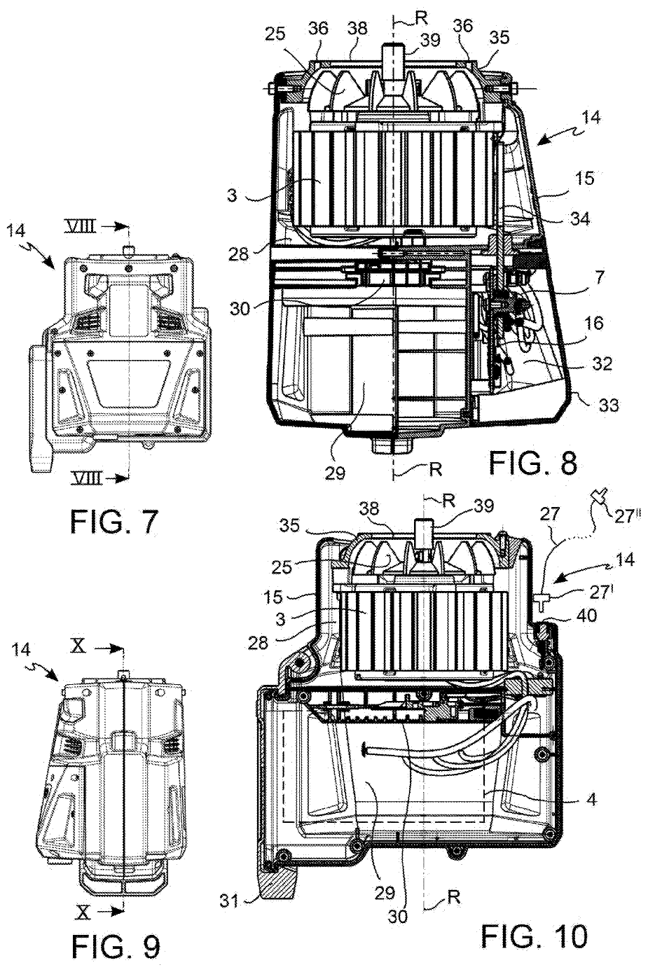

FIG. 7 is a top view of the motor module of the tool (wrench) in FIG. 1;

FIG. 8 is a sectional view of the motor module according to the cross-section plane VIII-VIII in FIG. 7;

FIG. 9 is a side view of the motor module of the tool (wrench) in FIG. 1;

FIG. 10 is a sectional view of the motor module according to the cross-section plane X-X in FIG. 9;

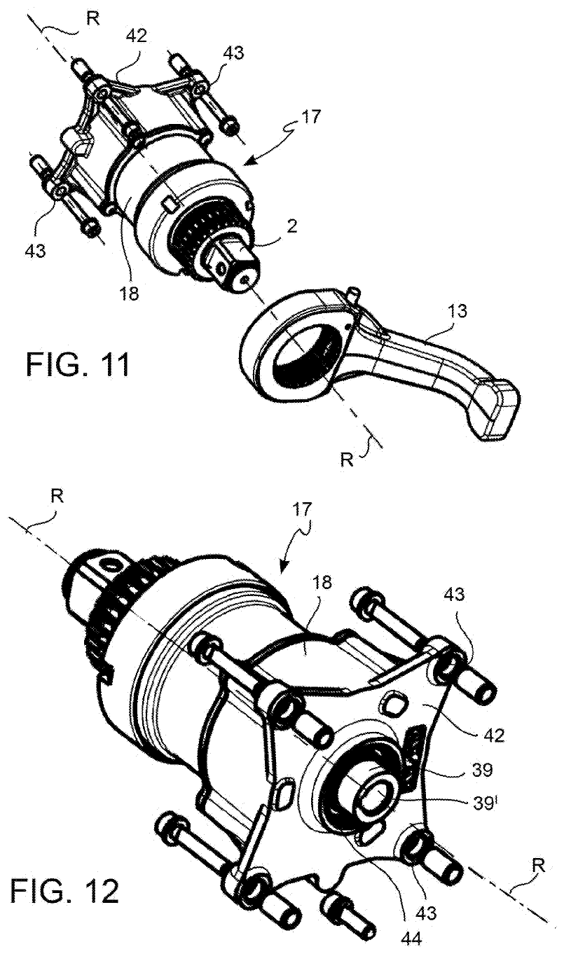

FIGS. 11 and 12 are perspective views of a reducer module of the tool (wrench) in FIG. 1;

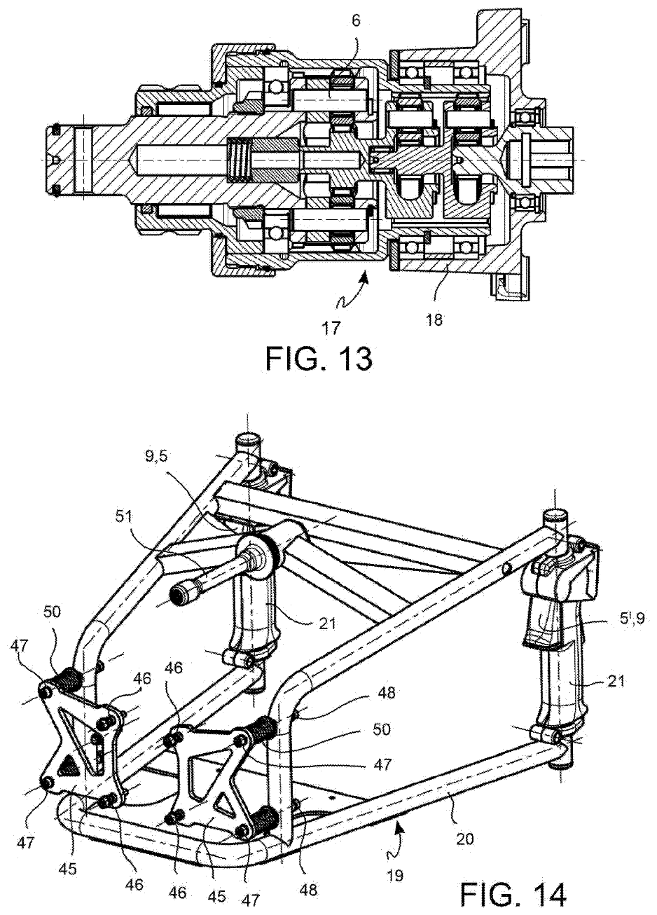

FIG. 13 is a sectional view of a reducer module of the tool (wrench) according to an embodiment;

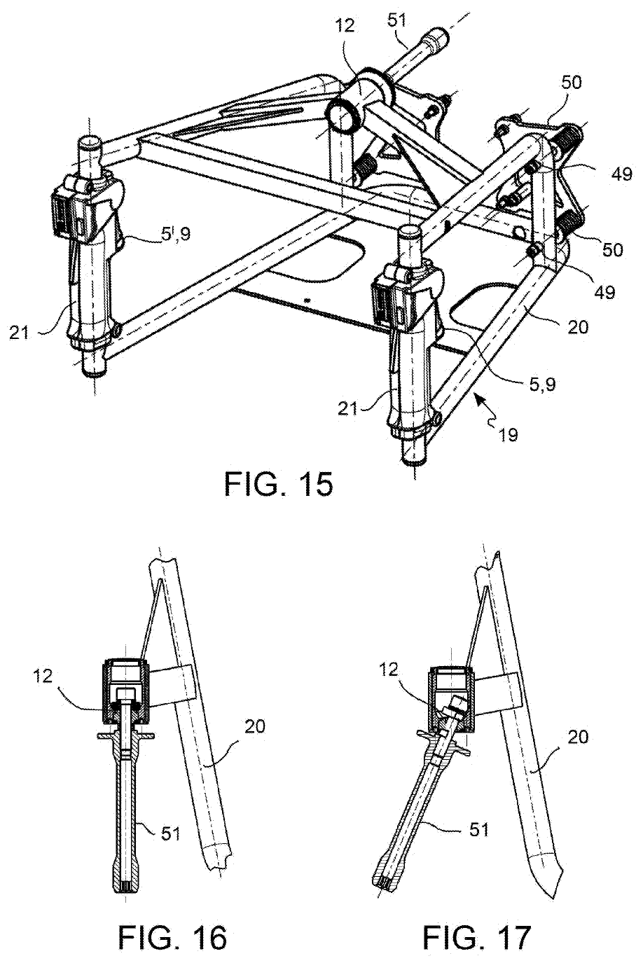

FIGS. 14 and 15 are perspective views of a handle module of the tool (wrench) in FIG. 1;

FIGS. 16 and 17 are sectional views of a detail of a handle module of a tool (wrench) according to an embodiment, in two different deformation states;

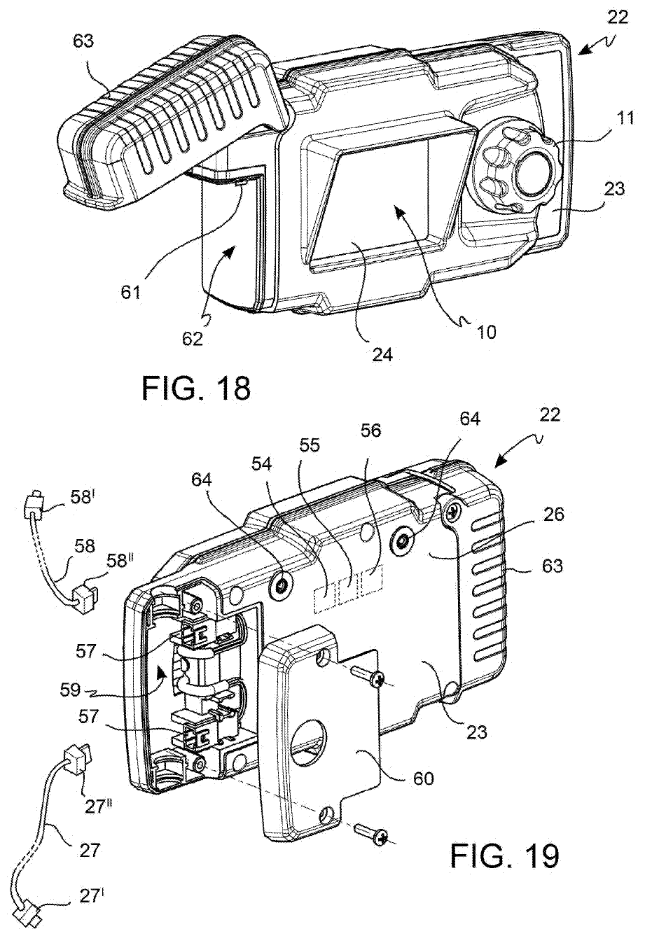

FIG. 18 is a perspective view of a control panel of the tool (wrench) in FIG. 1, in which a protective cover is partially open;

FIG. 19 is a perspective view of the control panel in FIG. 18 in which a connection door is detached from a housing of the control panel;

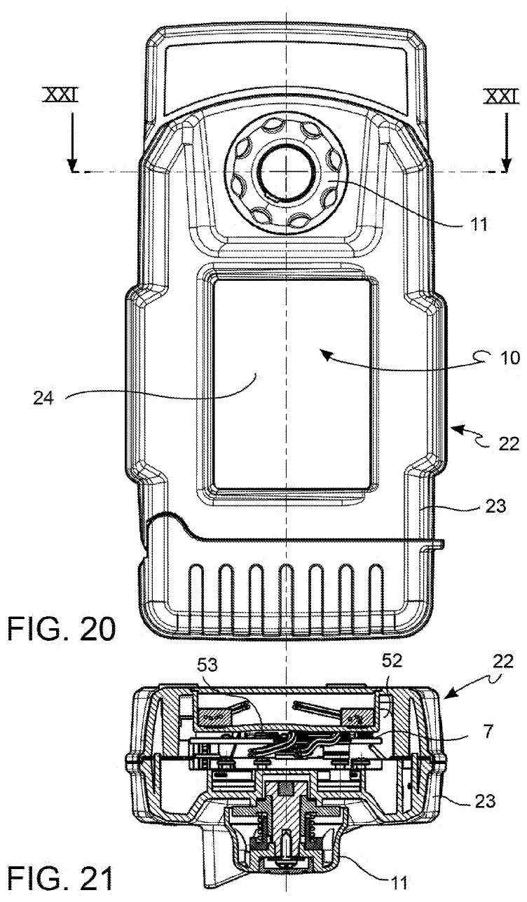

FIG. 20 is a view from a user side of the control panel in FIG. 18;

FIG. 21 is a sectional view of the control panel according to the cross-section plane XXI-XXI in FIG. 20;

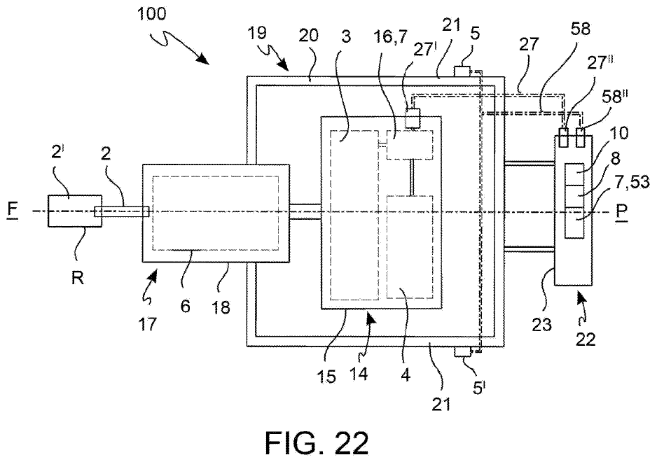

FIG. 22 is a diagrammatic view of a tool according to an embodiment of the invention.

### DESCRIPTION OF TOOL 100

With reference to the drawings, a tool 100 includes a working shaft 2 adapted to engage a working member or mechanism 2′. The working shaft 2 is rotatably supported about a rotation axis R. An electric motor 3 powered by one or more electric batteries 4 is adapted to generate the rotary motion and the torque required for the working operations of tool 100. For example, screwing/unscrewing, compressing, cutting, crimping operations.

Tool 100 further includes a reducer 6 connected between motor 3 and the working shaft 2. Reducer 6 interacts with motor 3 and with the working shaft 2 so as to transmit the rotary motion (transforming the angular speed and torque thereof) from motor 3 to the working shaft 2 to rotate the working shaft 2 about the rotation axis R.

Tool 1 further includes an electronic control system 7 connected to the at least one electric battery 4 and electric motor 3.

The electronic control system 7 includes:
an actuation device 5, 5′ for actuating motor 3, for example including one or more button or trigger actuation switches, and/or where the actuation of motor 3 occurs automatically in response to a predefined push support of the wrench tool 1 (by a working member or mechanism 2′) on an application or workpiece,
a memory 8 in which a calibration association between the working torque or force M of tool 100 and a corresponding electric current I absorbed by motor 3, for example a calibration function or calibration table with pairs of values (torque or force M, current I), is stored.

The electronic control system 7 is configured for:
detecting an instantaneous current I_inst of motor 3 during its operation,
detecting an actuation state of the actuation device 5, 5′,
controlling the power supply to the electric motor 3 depending on the detected actuation state, a target value of working force or torque M_tgt of the detected instantaneous current I_inst, and the stored calibration association.

Tool 100 includes:
a motor module 14 with its motor housing 15 which houses the electric motor 3, an electronic motor control board 16, and optionally, the electric battery 4,
a reducer module 17 with its reducer housing 18 which houses reducer 6,
a handle module 19 with its supporting structure 20 at which one or more gripping handles 21 are formed,
a control panel 22 with its panel housing 23 which supports a user interface 10 with a display 24 and a parameter selection member 11,
where the motor housing 15, the reducer housing 18, the supporting structure 20 and the panel housing 23 are individually self-supporting distinct components reversibly connectable to one another to form tool 100.

The control panel 22 and the motor module 14 are electrically connected by at least one fast connection plug 27′, 27″, for example by an electric wire 27 for power supply and/or (same wire or further wire) data transmission, extending at least for a segment outside the motor housing 15 and at least for a segment outside the panel housing 23 and having at least one fast connection plug 27′, 27″, (for example, one or more plugs according to Standard UL 1977), and/or by means of a docking interface with at least one fast connection plug.

### Description of Wrench 1

With reference to the drawings, a wrench 1 (embodiment of tool 100) includes a working shaft 2 adapted to support a bush 2′ or similar tools (embodiment of the working member 2′) for engaging the nuts or heads of the screws to be screwed, unscrewed. The working shaft 2 is arranged on a front side F of wrench 1 and rotatably supported about a rotation axis R. An electric motor 3, preferably a brushless motor, for example a 36 Volt three-phase brushless motor, powered by one or more (rechargeable) electric batteries 4, for example a 36 Volt, 6.2 Ah or 8 Ah rechargeable battery, can be arranged in a central region or on a rear side P of wrench 1, opposite to the front side F, and is adapted to generate the rotary motion and the torque required for the screwing/unscrewing operations.

Wrench 1 further includes a reducer 6 connected between motor 3 and the working shaft 2. Reducer 6 interacts with motor 3 and with the working shaft 2 so as to transmit the rotary motion (transforming the angular speed and torque thereof) from motor 3 to the working shaft 2 to rotate the working shaft 2 about the rotation axis R.

Wrench 1 further includes an electronic control system 7 connected to the at least one electric battery 4 and the electric motor 3.

The electronic control system 7 includes:
an actuation 5, 5′ and direction selection 9 device for actuating motor 3 and the selection of the rotation direction of the working shaft 2 (screwing or unscrewing), for example including one or more button or trigger actuation switches and/or a two-stable position direction selection switch, and/or where the direction selection function is implemented by the actuation device 5, 5′ itself, for example by a manual screwing actuation member 5 and a manual unscrewing actuation member 5′, and/or where the actuation of motor 3 occurs automatically in response to a predefined push support of wrench 1 (by bush 2′) on the head of a screw,
a memory 8 in which a calibration association between the unscrewing/screwing torque M (intended as “working” torque) of wrench 1 and a corresponding electric current I absorbed by motor 3, for example a calibration function or a calibration table with pairs of value (torque M, current I), is stored.

The electronic control system 7 is configured for:
detecting an instantaneous current I_inst of motor 3 during its operation,
detecting an actuation state of the actuation 5, 5′ and direction selection 9′ device,
controlling the power supply of the electric motor 3 depending on the detected actuation state, the selected rotation direction, a target torque screwing value M_tgt, the detected instantaneous current I_inst, and the stored calibration association.

Wrench 1 includes:
a motor module 14 with its motor housing 15 which houses the electric motor 3, an electronic motor control board 16, and optionally, the electric battery 4,
a reducer module 17 with its reducer housing 18 which houses/encloses reducer 6,
a handle module 19 with its supporting structure 20, to which two gripping handles 21 are formed,
a control panel 22 with its panel housing 23 which supports a user interface 10 with a display 24 and a parameter selection member 11,
where the motor housing 15, reducer housing 18, supporting structure 20 and panel housing 23 are individually self-supporting distinct components reversibly connectable to one another to form wrench 1.

The control panel 22 and the motor module 14 are electrically connected by at least one fast connection plug 27′, 27″, for example by an electric wire 27 for power supply and/or (same wire or further wire) data transmission, extending at least for a segment outside the motor housing 15 and at least for a segment outside the panel housing 23 and having at least one fast connection plug 27′, 27″, (for example, one or more plugs according to Standard UL 1977), and/or by means of a docking interface with at least one fast connection plug.

The tool 100, for example wrench 1, thus configured allows a modular and quick assembly of motors and reducers having different sizing and a control panel which allows the programming and selection of working parameters of tool 100 or wrench 1 for the specific conditions provided.

This obviates the need to use reducers with gear changer and electric motors performing in very broad operating ranges, and therefore with undesirably large sizes.

Tool 100, for example wrench 1, is manufacturable and configurable for different applications with reduced manufacturing, assembly and maintenance costs and times.

### Description of the Motor Module 14

According to an embodiment, the motor housing 15 internally forms a motor compartment 28 inside which is positioned the electric motor 3, a battery compartment 29 with an electric battery connection interface 30, in which the electric battery 4 is insertable and which is closable (and sealable) from the outer environment by a battery cover 31, preferably hinged and preferably made of rubber.

The motor housing 15 further forms an electric board compartment 32 in which the electronic motor control board 16 is placed, preferably closable and openable by a dedicated electric board cover 33 coupled with, for example screwed to, the motor housing 15.

The motor compartment 28 is cooled by a cooling air flow generated by a fan 25, for example coupled to the electric motor 3. The electric board compartment 32 is in heat exchange relationship (by a finned radiator 34) with the motor compartment 28, but separate from the motor compartment 28 so that the cooling air flow can indirectly cool the electronic motor control board 16 but cannot enter the electric board compartment 32, thus preventing the transport of dust and water drops towards the electronic motor control board 16.

According to an embodiment, the motor module 14, in particular the motor housing 15, includes a first connection wall 35, for example made of metal or reinforced composite fibre material or sintered material, with a plurality of, for example four, first threaded holes 36 for a threaded, reversible connection with the reducer module 17, for example by a plurality of four first screws 37, for example.

The first connection wall 35 forms a first central passage opening 38 through which a connection shaft portion 39 extends between the electric motor 3 and reducer 6. The connection shaft portion 39 is separable due to a torsion-proof insertion coupling 39′.

The motor module 14 further forms one or more fast connection sockets 40 connected with the electronic motor control board 16 and for a fast connection without tools with the or one of the fast connection plugs 27′, 27″, for example of the power supply and data transmission wire 27 or of the docking interface.

According to an embodiment, the motor module 14 includes one or more, preferably two, lighting devices 41, for example LED devices, directed towards a working position of tool 100, for example of wrench 1, and controlled by the electronic control system 7.

### Description of the Reducer Module 17

According to an embodiment, the reducer housing 18 (preferably made of metal) internally houses/encloses reducer 6 (this does not exclude the reducer housing 18 from contributing to the operation of reducer 6 itself), for example a planetary reducer having 1 or more reduction stages, preferably without a transmission ratio changer, and forms a second connection wall 42, for example made of metal or reinforced composite fibre material or sintered material, with a plurality of, for example four, second holes 43 for a reversible screw connection with the motor module 14, for example by the plurality of first screws 37.

The second connection wall 42 forms a second central passage opening 44 through which the connection shaft portion 39 extends between the electric motor 3 and reducer 6. The connection shaft portion 39 is separable due to the torsion-proof insertion coupling 39′.

According to an embodiment, the motor module 14 and the reducer module 17 are connected to one another by means of interposition of one or more distancing plates 45 projecting from the positions of the first threaded holes 36 and the second holes 43 away from the rotation axis R of the working shaft 2 to allow a connection of the handle module 19 outside the encumbrance of the reducer module 17 and/or motor module 14.

The distancing plate(s) 45 form:
a plurality of, for example four, third holes 46 for a connection of the one or more (preferably two) distancing plates 45 with the reducer module 17 and/or with the motor module 14 by the same first screws 37, and
a plurality of, for example four, fourth holes 47 for a connection of the distancing plate(s) 45 with the handle module 19, for example by second connection screws or bolts 48.

### Description of the Handle Module 19

According to an embodiment, the handle module 19 forms two gripping handles 21 and the actuation device 5, 5′ or the actuation and direction selection device 5, 5′, 9 is placed at one and both gripping handles 21.

The supporting structure 20 can include a metal tubular frame and forms a plurality of, for example four, frame connection holes 49 for connection of the handle module 19 with the reducer module 17 and/or with the motor module 14, for example by means of interposition of the aforesaid one or more distancing plates 45, for example by the second connection screws or bolts 48.

According to an embodiment, the connection of the handle module 19 with the reducer module 17 and/or with the motor module 14 is a connection moveable within certain limits and with the interposition of one or more elastic positioning springs 50 which elastically retain the handle module 19 in a planned position with respect to the motor module 14 and the reducer module 17, and therefore with respect to the rotation axis R of the working shaft 2, but which also allow a deviation from the planned position to enable the user to have an ergonomic, less tiring posture with respect to an obligated posture that would result from a planned position of a completely rigid tool.

According to an embodiment, the elastic positioning springs 50 are interposed between the distancing plate(s) 45 and the supporting structure 20, preferably at the second connection screws or bolts 48.

According to an embodiment, the power supply and data transmission wire 27 extends over at least one segment inside a tubular profile of the supporting structure 20, thus reducing the risk of damage to the wire itself.

According to an embodiment, the handle module 19 includes a carriage support rod 51 which allows coupling tool 100 or wrench 1 with a tool-carriage (not shown), for example with wheels moving along railway rails, for carrying out the working operations, for example screwing and unscrewing, in an easier manner.

Advantageously, the carriage support rod 51 forms a spherical joint 12 (FIGS. 16, 17) which simultaneously allows supporting and orientating the tool 100 or wrench 1 with respect to the tool-carriage.

### Description of the Control Panel 22

According to an embodiment, the panel housing 23 internally forms an electronic component compartment 52 inside which is positioned a local control electronic board 53 which controls the user interface 10, display 24 and the control member 11. The local control board 53 forms part of the electronic control system 7.

According to an embodiment, the electronic component compartment 52 further houses a Near Field electronic communication module (transceiver), i.e. Bluetooth, 54, a geolocation GPS (Global Positioning System) module 55, as well as a GSM (Global System for Mobile Communications) communication module (transceiver) 56 connected with or belonging to the electronic control system 7.

The electronic control system 7 is adapted and configured to associate, with each operation of tool 100, for example with each screwing of wrench 1:
date and time,
the position of tool 100, for example of wrench 1, and
technical parameters of the working operation performed,
and to generate a traceability file containing said data associations.

The traceability file or the individual data associations can be transmitted to a remote server (cloud) or remote electronic device (tablet, computer, smart phone) in batch mode (for example, at even lengthy time intervals or in response to a user control entered in the user interface 10) or in real time, for example via the Near Field electronic communication module (transceiver) 54 and/or the GSM (Global System for Mobile Communications) communication module (transceiver) 56.

According to an embodiment, the control panel 22 further forms one or more fast connection sockets 57 connected with the local control electronic board 53 and for a fast connection without tools with:
the fast connection plug(s) 27, 27′ of the power supply and data transmission wire 27 or the docking interface, and/or
a fast connection plug 58′, 58″ of a signal wire 58 connected to the actuation device 5, 5′ and/or direction selection device 5, 5′, 9.

According to an embodiment, battery 4 in the motor module 14 powers the motor control board 16. The motor control board 16 powers the local control electronic board 53 of the control panel 22 and exchanges data with the local control electronic board 53 of the control panel 22, for example by the power supply and data transmission wire 27, through the fast connection socket 40 and the fast connection socket 57, or by means of the docking interface.

The power supply and data transmission wire 27 can include, for example, a 4-pole electric wire.

The local control electronic board 53 of the control panel 22 is configured to receive screwing and unscrewing actuation signals (therefore of actuation and direction selection) from the actuation and direction selection device 5, 5′, 9, for example from the manual screwing actuation member 5 and the manual unscrewing actuation member 5′ (which can each include a switch or electric switch), for example through the signal wire 58. The local control electronic board 53 enables the rotation of motor 3 in the selected rotation direction by the data exchange with the motor control board 16.

The one or more fast connection sockets 57 are placed in a connection compartment 59 of the panel housing 23 closable and openable with a dedicated cover 60 coupled, for example screwed, with the panel housing 23. Cover 60 can form a passageway hole for the wires to be connected to the control panel 22.

According to an embodiment, the control panel 22 further forms a connection socket 61 for an external data support, for example a USB socket for the connection of a USB memory flash drive, connected with the local control electronic board 53 for the transmission of the aforesaid traceability file or the individual data associations on an external data support (for example, a USB flash drive) and/or for the transmission of technical control parameters from an external data support (for example, a USB flash drive) to the control system 7.

The connection socket 61 for external data support is placed in a second connection compartment 62 of the panel housing 23 closable and openable with a dedicated second cover 63 (for example, made of elastomeric material) coupled, for example hinged, with the panel housing 23, and openable and closable without using tools.

According to an embodiment, the control panel 22, in particular the panel housing 23, includes a third connection wall 26 with a plurality, for example three, of threaded holes 64 for a reversible threaded connection with the handle module 19 or with the motor module 14, for example by a plurality of, for example three, screws 65.

The control system 7 of tool 100, for example wrench 1, can be distributed on the motor module 14 and the control panel 22. Alternatively, the control system 7 can be housed in the motor module 14 (for example, in the form of motor control board 16) and the control panel 22 houses accessory and peripheral devices in signal connection with the control system 7.

### Description of Parameter Selection

According to an embodiment, the user interface 10 allows the selection or setting of the values of operation parameters of tool 100, for example of wrench 1, by a two-level selection input, where a first input level includes the selection of the operation parameter among a plurality of different operation parameters, and a second input level includes the selection or setting of a value of the selected operation parameter among a plurality of different parameter values.

In the embodiment of wrench 1, the selectable operation parameters include two or more of:
the type of connection to be screwed W, N, K, KS, or the corresponding target torque value M_tgt,
the screwing sequence SSSS, FFFF, SSFF, SFSF, FREE of a series of screwing operations,
the option to generate a log file of the screwing/unscrewing operations,
the display of the total number of screwing/unscrewing operations performed and/or of a partial number of screwing/unscrewing operations performed starting from a reset to be performed by the user,
the display of the total number of operation hours and minutes of wrench 1 and/or of a partial number of operation hours and minutes of wrench 1 starting from a reset to be performed by the user,
the display brightness,
data download onto external memory support, for example USB flash drive,
display and adjustment of date and time.

The values of the settable or selectable operation parameters include, for example:
a plurality of connection codes or symbols W, N, K, KS, or a plurality of numeric torque values as values for the type of connection to be screwed or for the target torque value M_tgt, and/or
a plurality of different screwing sequences SSSS, FFFF, SSFF, SFSF, FREE as value for the screwing sequences, and/or
YES and NO as value for the parameter for generating a log file of the screwing/unscrewing operations, and/or
initializing at zero as value of the partial number of performed screwing/unscrewing operations,
initializing at zero as value of the partial number of operation hours and minutes of wrench 1,
an “intense brightness” symbol and a “less intense brightness” symbol as values or limit adjustment values for the adjustable brightness of the display, and/or
a download symbol as value for the download parameter of data onto the external memory support.

According to an embodiment, the selection of the operation parameters and the selection or setting of the values of the operation parameters is assisted by a visualization by means of a display.

According to an advantageous, particularly ergonomic embodiment, the user interface 10 includes one rotating knob 11 alone and is responsive to both the rotation and pressing of the knob, where:
the selection of the operation parameter in the first input level occurs by rotating knob 11,
the transition from the selection of the operation parameter to the second input level for the selection or setting of a parameter value occurs by pressing knob 11,
the selection of the operation parameter value in the second input level occurs again by rotating knob 11 or, in the case of a selection between only two different values, by the same pressing of knob 11,
the confirmation of the selected or set parameter value in the second input level occurs by pressing knob 11.

The rotating knob 11 can be associated with a Hall sensor for generating a selection signal by rotating the knob and with a magnetic proximity sensor for generating a distinct selection signal by pressing knob 11.

Certain technical features in the description and claims are defined as a “first feature”, a “second feature”, a “third feature”, for example a first/second/third/ . . . plug, a first/second/third/ . . . wall, a first/second/third/ . . . compartment, a first/second/third/ . . . cover. The numeral adjectives “first/second/third/ . . . ” are meant only as a proper name of the feature indicated and, for example, the presence in the claims of a feature defined as a “second feature” or a “third feature” does not mean the necessary presence of a further feature identified by the numeral adjective “first”.

### REFERENCE SIGNS

wrench 1
working shaft 2
working member or mechanism, bush 2′
electric motor 3
battery 4
actuation and direction selection device 5, 5′, 9
manual screwing actuation member 5
manual unscrewing actuation member 5′
reducer 6
electronic control system 7
memory 8
direction selector 9
user interface 10
rotating knob 11
spherical joint 12
reaction arm 13
motor module 14
motor housing 15
motor control board 16
reducer module 17
reducer housing 18
handle module 19
supporting structure 20
gripping handle 21
control panel 22
panel housing 23
display 24
fan 25
third connection wall 26
power supply and/or data transmission wire(s) 27
fast connection plug 27′, 27″
motor compartment 28
battery compartment 29
electric battery connection interface 30
battery cover 31
electric board compartment 32
electric board cover 33
finned radiator 34
first connection wall 35
first threaded holes 36
first screws 37
central passage opening 38
connection shaft portion 39
insertion coupling 39′
fast connection socket 40
lighting device 41
second connection wall 42
second holes 43
second central passage opening 44
distancing plates 45
third holes 46
fourth holes 47
second connection screws or bolts 48
frame connection holes 49
elastic positioning springs 50
carriage support rod 51
electronic component compartment 52
local control electronic board 53
Near Field communication module 54
geolocation GPS module 55
GSM communication module 56
fast connection sockets 57
signal wire 58 for actuation member
fast connection plug 58′, 58″
connection compartment 59
connection compartment cover 60
connection socket 61 for external data support
second connection compartment 62
second cover 63
threaded holes 64
screws 65
tool 100
front side F
rear side P
rotation axis R
electric current I absorbed by the motor
detected instantaneous current I_inst
torque M applied by the wrench
target torque value M_tgt

1-18. (canceled)

19. A wrench, comprising:
a working shaft,
an electric motor powered by at least one electric battery,
a reducer connected between the motor and the working shaft,
an electronic control system connected to the electric battery and the electric motor, wherein the electronic control system includes:
an actuation and direction selection device for actuating the motor and selecting the rotation direction of the working shaft,
a memory wherein a calibration association between the screwing torque of the wrench and a corresponding electric current absorbed by the motor is stored,
wherein the electronic control system is configured for:
detecting an instantaneous current of the motor during its operation,
detecting an actuation state of the actuation and direction selection device,
controlling a power supply of the electric motor depending on the detected actuation state, the selected rotation direction, a target torque screwing value, detected instantaneous current, and stored calibration association,
wherein the wrench includes:
a motor module with an own motor housing, which houses the electric motor and an electronic board for motor control,
a reducer module with an own reducer housing, which houses the reducer,
a handle module with an own supporting structure, to which one or more gripping handles are formed,
a control panel with an own panel housing, which supports a user interface with a display and a parameter selection member,
wherein motor housing, reducer housing, supporting structure and panel housing are distinct components, individually self-supporting, and reversibly connectable one to the other to form the wrench,
wherein control panel and motor module are electrically connected by at least one fat connection plug.

20. The wrench of claim 19, wherein the motor module includes a fast connection socket connected with the electronic board for motor control and for fast connection without tools with said fast connection plug,
wherein the motor housing forms:
a motor compartment in which the electric motor is located,
a battery compartment with an interface for electric battery connection, in which the electric battery can be inserted, and wherein said battery compartment can be closed to the outer environment by a battery cover of the motor module,
an electric board compartment in which the electronic board for motor control is located, preferably that can be closed and opened by a dedicated electric board cover coupled with or screwed to the motor housing;
a first connection wall with a plurality of first holes for a reversible connection with the reducer module by means of a plurality of first screws.

21. The wrench of claim 19, wherein the control panel and the motor module are electrically connected by:
an electric wire for power supply and/or data transmission, extending for at least a segment outside the motor housing and extending for at least a segment outside the panel housing and having said at least one fast connection plug, or
a plug interface having said at least one fast connection plug.

22. The wrench of claim 19, wherein the reducer housing supports a reducer without a transmission ratio changer, and forms a second connection wall with a plurality of holes for a reversible connection, by screws with the motor module.

23. The wrench of claim 19, wherein the motor module and the reducer module are connected one to the other via the interposition of one or more distancing plates projecting from screwing connection positions between the motor module and reducer module away from the rotation axis of the working shaft, and carry out a connection of the handle module with the distancing plate outside the encumbrance of the reducer module and/or motor module.

24. The wrench of claim 23, wherein the one or more distancing plates form:
a plurality of third holes for connection of the one or more distancing plates with the reducer module and with the motor module via first screws, and
a plurality of fourth holes for connection of the one or more distancing plates with the handle module by second connection screws or bolts.

25. The wrench of claim 19, wherein:
the handle module forms two gripping handles and the actuation and direction selection device is placed at one and/or both gripping handles,
the supporting structure includes a metal tubular frame and forms a plurality of frame connection holes for connection of the handle module with the reducer module and/or with the motor module via connection screws or bolts.

26. The wrench of claim 19, wherein the connection of the handle module with the reducer module and/or with the motor module is a moveable connection within certain limits, due to the interposition of one or more positioning elastic springs,
wherein the one or more positioning elastic springs elastically retain the handle module in a planned position in relation to the motor module and to the reducer module and in relation to the rotation axis of the working shaft but also allow a deviation from the planned position to enable the user to have an ergonomic posture different from a hypothetical posture that would result from a planned position of a completely rigid tool.

27. The wrench of claim 23, wherein the one or more positioning elastic springs are interposed between the one or more distancing plates and the supporting structure at the connection screws or bolts between them.

28. The wrench of claim 19, wherein the control panel and the motor module are electrically connected by an electric wire for power supply and/or data transmission and having said at least one fast connection plug, and wherein the wire for power supply and/or data transmission extends for at least a segment inside the tubular profile of the supporting structure.

29. The wrench of claim 19, wherein the handle module includes a carriage support rod that allows to couple the wrench with a tool-carriage, wherein the carriage support rod forms a spherical joint that allows at the same time support and orientation of the wrench relative to the tool-carriage.

30. The wrench of claim 19, wherein the panel housing internally forms an electronic component compartment inside which are positioned:
a local control electronic board, controlling the user interface,
an electronic module for near field or Bluetooth communication,
a geolocation GPS module,
a GSM communication module of the electronic control system,
wherein the control panel forms one or more fast connection sockets connected with the local control electronic board and for a fast connection without tools with said fast connection plug and/or with a further fast connection plug of a signal wire connected to the actuation and direction selection device.

31. The wrench of claim 30, wherein the one or more fast connection sockets are placed in a connection compartment of the panel housing, wherein the connection compartment can be closed and opened with a dedicated cover coupled with the panel housing, wherein the cover forms a passageway for the wires connected to the control panel.

32. The wrench of claim 19, wherein the control panel includes a connection socket for an external data support, or a USB socket for the connection of a USB memory flash drive, connected with the local control electronic board for the transmission of a traceability file on an external data support and/or for the transmission of technical control parameters from an external data support to the control system.

33. The wrench of claim 32, wherein the connection socket for external data support is placed in a second connection compartment of the panel housing that can be closed and opened with a dedicated second cover coupled with the panel housing and that can be opened and closed without using tools.

34. The wrench of claim 19, wherein the control panel includes a plurality of holes for a reversible screw connection with the handle module or with the motor module.

35. The wrench of claim 19, wherein the user interface allows a selection of the values of operation parameters of the wrench, by a two-level selection input, wherein a first input level includes the selection of an operation parameter among a plurality of different operation parameters, and a second input level includes the selection or setting of a value of the selected operation parameter, among a plurality of different parameter values,
wherein the user interface includes a rotating knob and is responsive both to the rotation and pressure of the knob, wherein:
selection of the operation parameter in the first input level occurs by rotating the knob,
transition from the selection of the operation parameter to the second input level for the selection or setting of a parameter value occurs by pressing the knob,
selection of the operation parameter value in the second input level occurs by rotating the knob.

36. A portable tool, comprising:
a working shaft,
an electric motor powered by at least one electric battery,
a reducer connected between the motor and the working shaft,
an electronic control system connected to the electric battery and to the electric motor, wherein the electronic control system includes:
an actuation device for actuating the motor,
a memory wherein a calibration association between the working torque or force of the tool and a corresponding electric current absorbed by the motor is stored,
wherein the electronic control system is configured for:
detecting an instantaneous current of the motor during its operation,
detecting an actuation state of the actuation device,
controlling the power supply to the electric motor depending on the detected actuation state, a target value of force or torque to be applied by the tool, the detected instantaneous current, and the stored calibration association,
wherein the tool further comprises:
a motor module with an own motor housing, which houses the electric motor and an electronic motor control board,
a reducer module with an own reducer housing, which supports the reducer,
a handle module with an own supporting structure, at which one or more gripping handles are formed,
a control panel with an own panel housing, which supports a user interface with a display and a parameter selection member,
wherein the motor housing, the reducer housing, the supporting structure and the panel housing are individually self-supporting, distinct components, reversibly connectable one to the other to form the tool,
wherein control panel and the motor module are electrically connected by at least one fast connection plug.
